(19) United States
(12) Patent Application Publication
(10) Pub. No.: US 2011/0138432 A1
(43) Pub. Date: Jun. 9, 2011

(54) Media Bookmarks

(75) Inventors: Nilo Mitra, New York, NY (US); George Foti, Dollard des Ormeaux (CA); Paul Higgs, Roswell, GA (US)

(73) Assignee: TELEFONAKTIEBOLAGET L M ERICSSON (PUBL), Stockholm (SE)

(21) Appl. No.: 13/057,705

(22) PCT Filed: Aug. 6, 2008
(86) PCT No.: PCT/US08/72369

§ 371 Date: Feb. 4, 2011

(51) Int. Cl. H04N 7/173; H04N 9/80

(52) U.S. Cl. 725/109; 386/241; 386/E05.003

(57) ABSTRACT

Specific instances in time, e.g., scenes, in a program or other media content can be marked in an unambiguous manner. A scene's marking information, which can be called a bookmark, is preferably stored in communication network as a part of a user's service profile. With such a bookmark, a user can, among other things, resume watching a program from the bookmarked point onwards on the same or a different media device, and send the bookmark to others, e.g., as a link in chat or other social networking interactions, so that they can watch the program from or around the bookmarked scene (provided, of course, that they have rights to access that content).

### BACKGROUND

This invention relates to electronic communication networks, and more particularly to media content delivery in packet-switched communication networks.

Common web browser applications, such as Mozilla's Firefox and Microsoft's Internet Explorer, provide for bookmarks that allow a user to return to specific Internet pages and other file locations accessible by the browser. Each page is identified by a

Uniform Resource Identifier (URI), which is recorded whenever a user creates a bookmark for that page. The user can give the bookmark a more easily remembered, user-friendly name, sort and categorize bookmarks into folders, etc.

Internet Protocol Television (IPTV) also uses browser technology to enable IPTV Service Providers to provide media services deployed in communication networks, such as wired and wireless telephone networks. In general, IPTV is a system for receiving and displaying multimedia streams encoded as series of IP data packets. Work on IPTV is underway in several contexts, including for example the Open IPTV Forum, which is specifying an end-to-end platform for supplying multimedia and IPTV services to user equipments (UEs) over the Internet and managed networks having controlled quality-of-service (QoS) performance. A version 1.1 specification of a functional IPTV architecture is available at www.openiptvforum.org, and the architecture uses the IP Multimedia Subsystem (IMS) that is specified by the Third Generation Partnership Project (3GPP). A UE can access services offered through an IMS in many ways, both wireline (e.g., Ethernet, cable modem, digital subscriber line, etc.) and wireless (e.g., 3GPP-specified cellular radio, IEEE 802.11, IEEE 802.16, etc.).

The IMS is specified in 3GPP Technical Specification (TS) 23.228 V8.4.0, IP Multimedia Subsystem (IMS) Stage 2 (Release 8), March 2008, and previous versions of TS 23.228. IMS is described in, for example, R. Noldus et al., “Multi-Access for the IMS Network”, Ericsson Review No. 2, pp. 81-86 (2008); U. Olsson et al., “Communication Services—The Key to IMS Service Growth”, Ericsson Review No. 1, pp. 8-13 (2008); and P. Arberg et al., “Network Infrastructure for IPTV”, Ericsson Review No. 3, pp. 79-83 (2007). Approaches to IMS-based IPTV are described in M. Cedervall et al., “Open IPTV Forum—Toward an Open IPTV Standard”, Ericsson Review No. 3, pp. 74-78 (2007), and T. Cagenius et al., “Evolving the TV experience: Anytime, Anywhere, Any Device”, Ericsson Review No. 3, pp. 107-111 (2006).

The IMS in 3GPP networks uses the Session Initiation Protocol (SIP) and the Session Description Protocol (SDP) as its basic signaling mechanisms. SIP is a mechanism defined in Request for Comment (RFC) 3261 by the Internet Engineering Task Force (IETF) for finding endpoints and routing control signals between them and is a set of simple operations, including REGISTER, INVITE, ACK, and BYE. SDP is a protocol for declaring media. In IMS networks, media transport is based on the real-time transport protocol (RTP), among others. 3GPP TS 24.229 V7.11.0, IP Multimedia Call Control Protocol Based on Session Initiation Protocol (SIP) and Session Description Protocol (SDP), Stage 3, Release 7 (March 2008) specifies an IP Multimedia Call Control Protocol based on SIP and SDP. Section 5 of TS 24.229 specifies SIP usage at a UE, and Section 6 of TS 24.229 specifies SDP usage.

For a UE, which for IPTV can be a set-top box (STB) or a TV having integrated STB capabilities, to access an IMS and IPTV services, the UE registers in a serving call session control function (S-CSCF), which is an IMS core node and is in essence a SIP server. The IMS also includes a number of access nodes, including a proxy CSCF (P-CSCF), a media gateway control function (MGCF), and one or more border gateways (BGs), that mediate UE access to the core nodes and through them to content residing on media servers. The UE may include an IP multimedia subscriber identity module (ISIM), which is an application, or computer program, residing on a universal integrated circuit card (UICC) that enables the UE to register and access the IMS. The ISIM is typically preconfigured with parameters necessary to initiate the UE's registration to the IMS, including a private user identity, one or more public user identities, and a home network domain name.

The current TV experience provided by IPTV does not allow a user to identify a particular scene in a program, delivered by either live streaming or video-on-demand (VoD), so as to be able to go back to that scene with minimal effort. For live streaming, the user has to store the program and then rewind to the scene desired, which is a time consuming affair. VoD may offer predefined “scene selections” that can help narrow down the location of a desired scene, but the actual scene desired still has to be manually discovered.

Another drawback of the current TV experience is the inability of a user to retrieve a desired scene from another viewing device unless that other device has access to the same local storage as that of the original viewing device. Today, it is also typically not possible to intervene in an on-going program without changing the viewing characteristics, e.g., freezing the frame during a pause, which can affect the viewing experience of those watching the program.

### SUMMARY

In one aspect of this invention, there is provided a method of bookmarking media information displayed to a user of an electronic communication network. The method includes generating a bookmark request message; sending the bookmark request message to a control server in the communication network; and updating a list of bookmarks based on the bookmark request message. The bookmark request message includes at least an identifier of the user, an identifier of the media information, a time indicator, and a bookmark display name.

In a further aspect of this invention, there is provided a user equipment for an electronic communication network for accessing and rendering media information. The user equipment includes a transceiver configured to exchange electronic signals with one or more entities in the network; an electronic processor programmably configured to handle information carried by the electronic signals according to instructions in a memory; and a device configured to provide user input to the electronic processor. The processor is configured for an Internet Protocol Television (IPTV) function able to bookmark media information displayed to a user at least by generating a bookmark request message that includes at least an identifier of the user, an identifier of the media information, a time indicator, and a bookmark display name; and sending the bookmark request message to a control server in the communication network.

In a further aspect of this invention, there is provided an IPTV user profile server for storing and retrieving bookmarks on request. The server includes a transceiver configured for exchanging electronic signals with one or more entities of an electronic communication network; an electronic processor programmably configured to handle information carried by the electronic signals; and a memory configured to store retrievable bookmarks. The processor is configured to store a list of media information bookmarks in association with a profile of a user, the list including at least an identifier of the media information, a time indicator, and a bookmark display name.

### BRIEF DESCRIPTION OF THE DRAWINGS

The several features, objects, and advantages of this invention will be understood by reading this description in conjunction with the drawings, in which:

FIG. 1 depicts a communication network and a signal flow among communication network entities in a method of media bookmarking;

FIG. 2 depicts an example of a bookmark message according to the session initiation protocol;

FIG. 3 depicts an example of a message according to the XML configuration access protocol;

FIG. 4 depicts another communication network and another signal flow among communication network entities in a method of media bookmarking;

FIG. 5 depicts another example of a message according to the XML configuration access protocol;

FIG. 6 depicts an example of a message for returning retrieved bookmarks;

FIG. 7 is a block diagram of a user equipment;

FIG. 8 is a block diagram of an IPTV user profile server; and

FIG. 9 is a flowchart that depicts a method of retrieving a bookmark.

### DETAILED DESCRIPTION

As described in more detail below, the inventors have recognized that specific instances in time, e.g., scenes, in an IPTV program, or more generally media content accessed through an IMS, can be marked in an unambiguous manner. A scene's marking information, which can be called a bookmark, is preferably stored in the network, e.g., as a part of a user's IMS or IPTV service profile. Storing marking information in the network rather than a local device enables a bookmark to be accessed from anywhere, with any device. The artisan will understand that bookmarking implies a future return to a scene in a program, and so it can be assumed that the program will continue to be accessible for at least some period of time, e.g., by non-volatile storage in some way.

With such a bookmark, a user can, among other things, resume watching a program from the bookmarked point onwards on the same or a different media rendering device, and send the bookmark to others, e.g., as a link in chat or other social networking interactions, so that they can watch the program from or around the bookmarked scene (provided, of course, that they have rights to access that content).

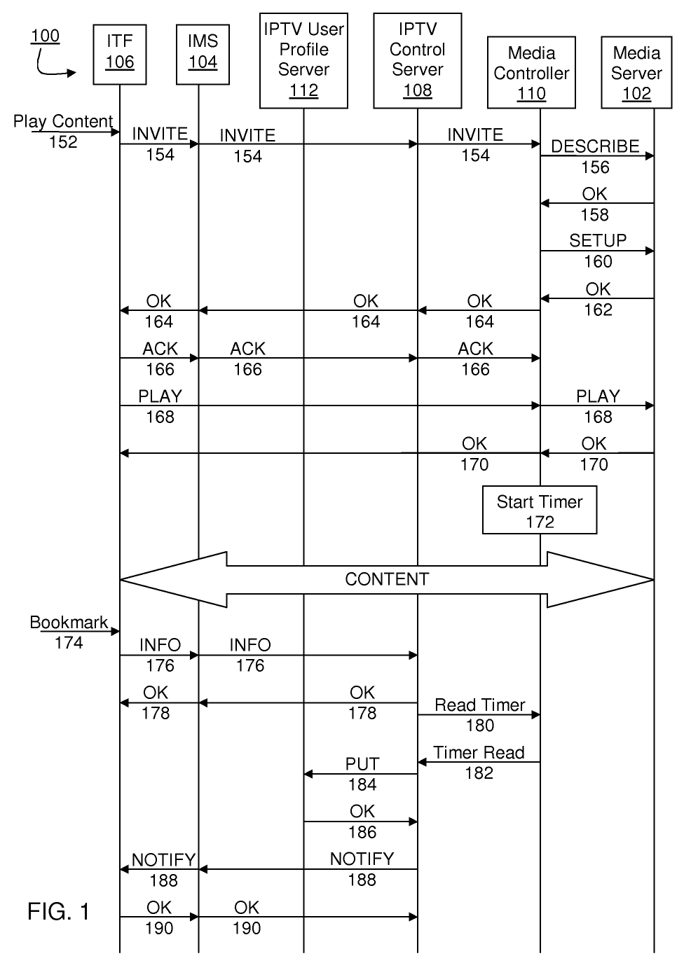

FIG. 1 depicts a typical signal flow among entities in a communication network 100 in a method of media bookmarking for content-on-demand (CoD) in accordance with this invention. It will be understood that the method depicted is in a context of an IMS, employing messages appropriate for an IMS, but in general other contexts and other types of messages can be used.

In step 152, a user indicates a request to view a set of media information, for example, media content that is available on a Media Server 102 that the user can access with a device such as a UE or set-top box through an IMS 104. The user may indicate the request in many ways, for example by clicking on a link or URI in a browser application running on the UE.

Steps 154-166 relate to the process of establishing an IMS session for the requested content. In step 154, an IPTV terminal function (ITF) 106 in the UE arranges for a SIP INVITE message to be sent to the IMS 104, which forwards the INVITE message to an IPTV control server 108 associated with the IMS. The artisan will understand that a SIP INVITE message is appropriate in the context of an IMS, and other types of messages can be used in other contexts.

The ITF 106 is the functionality in the UE, such as a STB, integrated TV/STB, personal computer, mobile telephone, or other user device, that enables IPTV media information to be selected and displayed to a user. As with the other functionalities described in this application, the ITF 106 is typically implemented by a suitably programmed electronic processor or equivalent with memory in the UE that handles information carried by signals exchanged by the UE and other entities in the network 100. The IPTV control server 108 is such a programmed processor implementing functions that determine and control the media information available to the user.

The IPTV control server 108 forwards the user's request to a media controller 110, which in step 156 sends a DESCRIBE message to the Media Server 102 having the content requested by the user. The DESCRIBE message can be a Real-Time Streaming Protocol (RTSP) message or a message according to another suitable protocol. In step 158, the Media Server 102 responds to the media controller 110 with a RTSP 200 OK message that includes a RTSP session identifier. In step 160, the media controller 110 sends the Media Server 102 a RTSP SETUP message including the session identifier, to which the Media Server responds in step 162 with a RTSP 200 OK message. In step 164, the media controller 110 passes a SIP 200 OK message including the RTSP session identifier to the ITF 106 through the IPTV control server 108 using the IMS 104. In step 166, the ITF 106 responds with an appropriate acknowledgement message that passes from the IMS 104 to the IPTV control server 108 and media controller 110 and indicates that the IMS session is established.

Steps 168 and 170 relate to the process of playing the content by the user. In step 168, the user's ITF 106 sends to the media controller 110 an RTSP PLAY message including the established session identifier that is forwarded to the Media Server 102. In step 170, the Media Server 102 responds to the media controller 110 with a RTSP 200 OK message including the session identifier that the media controller 110 forwards to the ITF 106. The media controller 110 records the starting time for the play request for future use in establishing any bookmark(s) (step 172), for example by starting a suitable timer. Content delivery from the Media Server 102 to the UE's ITF 106 ensues, without passing through the IMS control plane. When the content is interactive, appropriate information is exchanged by the Media Server 102 and ITF 106, as indicated by the double-headed arrow.

In step 174, the user indicates to the ITF 106 a request to bookmark a point or scene in the content, for example by clicking on the UE's display or a particular button or other control device associated with bookmarking on the UE, remote control, etc. In response to the user's request, bookmark functionality in the ITF 106 can suggest a display name for the bookmark, which may be based on the title of the content and/or other characteristics. The user can modify the suggested display name of the bookmark at the time the bookmark is requested or later through a suitably programmed procedure for modifying stored bookmarks.

In step 176, the ITF 106 sends a SIP INFO message to the IMS 104 that is forwarded to the IPTV control server 108. The INFO message or other suitable message that carries the bookmark information includes one or more information elements that are based on the media content and viewing time, among other things. In step 178, the IPTV control server 108 responds to the INFO message with a SIP 200 OK message that is forwarded by the IMS 108 to the ITF 106.

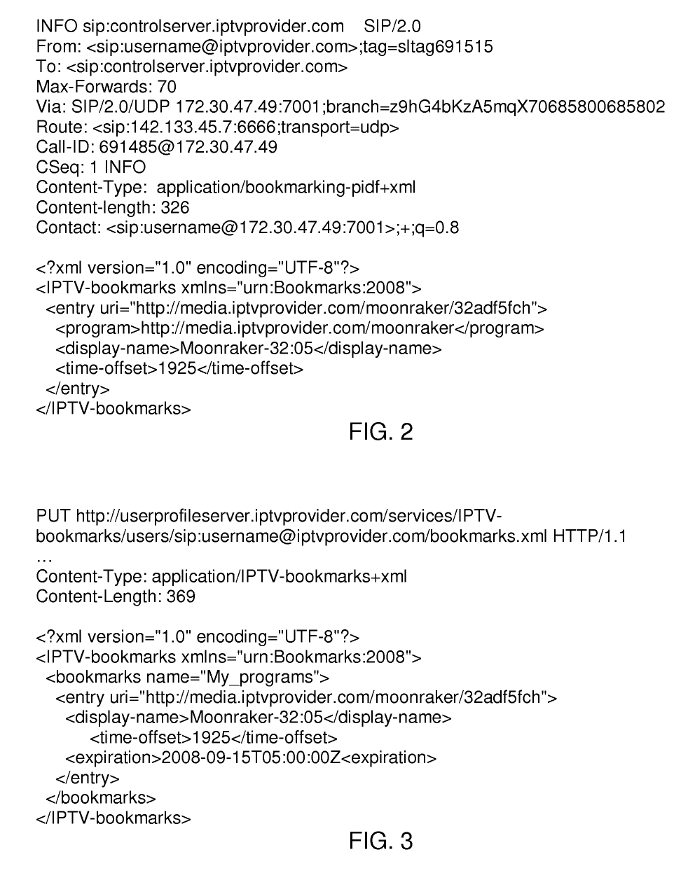

An example of a bookmark message is depicted in FIG. 2, which shows a SIP

INFO message that includes the URI of the program (“<entry uri= . . . ”), a time offset, or displacement, from the start of the program (“<time-offset> . . . ”), and the bookmark display name (“<display-name . . . >”). In FIG. 2, the line IPTV-bookmarks xmins=“urn:Bookmarks:2008” indicates the schema where the definition of the IPTV-bookmarks is made, and includes an example of a value for that information element. Translated from SIP into English, the line can be read as “Here is the complex type known as IPTV-Bookmarks, which contains elements and attributes defined by the schema that can be found at urn:Bookmarks:2008”. It will be noted that the user, who in FIG. 2 is identified by the information element sip:username@iptvprovider.com, is known to the IPTV control server 108 from a previous identification and authentication procedure, during which the user registered with the network from that ITF 106. For content-on-demand as an example, a suitable bookmark message includes at least the following information elements: the URI identifying the media content, a time indicator, and the bookmark display name. As described above, the URI and display name are already known to the ITF 106, and the time indicator can be a flag or a time value as described below.

The IPTV control server 108 may determine that the program being bookmarked is available only for a finite period of time either due to availability of the program itself or due to some considerations relating to the use of bookmarking by the user. If the bookmark is available only for such a finite period of time, the IPTV control server 108 can add an <expiration> element to the pertinent bookmark information.

The artisan will understand that SIP INFO messages are just examples of bookmark messages and that other kinds of messages and other protocols can be used. The bookmark message, such as a SIP INFO message, can include a variety of information elements as necessary to return to a current state of the media information being displayed. For example, if the content is associated with a game, the bookmark message would include game metadata sufficient to restore a state of the game when the bookmark is retrieved. An example of this would be if the media information includes an interactive quiz show, bookmarking the content at a particular point would record the user's score and the scores of the other participants at that point in time. Later, when the user resumes the content from that bookmark, the state of the quiz would be restored.

A timer or another suitable mechanism is used to determine the time displacement from a start of the content to a bookmark time, such as a time of generating the bookmark request. As depicted in FIG. 1, the media controller's timer is started (step 172) upon confirmation of the user's play request (step 168). For example, the time indicator can be a time displacement value determined by a suitable timer in the ITF 106, or the time indicator can be a flag that causes a suitable timer in the media controller 110 to be read, which is depicted by step 180. An elapsed time value or other suitable indication is retrieved in step 182 upon receipt of the bookmark request (step 176).

Considering practical aspects of bookmarking, there is typically a lag between the time when the user realizes that a bookmark should be created and the time when the user actually presses a “bookmark” button and the bookmark request is generated. Thus, the bookmark time should be set as some time earlier than when the ITF receives the bookmark request. One option is to have the media controller 110 arranged to subtract a suitable “reaction time” in its retrieval of the elapsed time value. As an alternative, the ITF 106 could be arranged to subtract a “reaction time” from the actual elapsed time retrieved by the media when the user selects the bookmark for play-back. The amount of “reaction time” could be selectable by the user and stored as another aspect of the user's profile.

In steps 184 and 186, the IPTV control server 108 updates a list of bookmarks that are preferably part of a respective user profile stored by the IPTV control server 108 or by an associated IPTV user profile server 112. A copy of the user profile can be maintained at the user's ITF 106. The updating advantageously uses the eXtensible Markup Language (XML) Configuration Access Protocol (XCAP), which is an efficient mechanism for updating the user profile with the new bookmark. In step 184, the IPTV control server 108 sends the IPTV user profile server 112 an XCAP PUT message that includes pertinent bookmark information, such as the bookmark address, URI for the content, the time displacement, an indication of an expiration time (if any) of the bookmark, and the bookmark display name. In step 186, the IPTV user profile server 112 responds with a message, such as a hypertext transfer protocol (HTTP) 200 OK message, to indicate successful creation of the bookmark.

In step 188, the user's local bookmark application on the ITF 106 is notified of the added bookmark by a SIP NOTIFY message sent from the IPTV control server 108 to the ITF 106. In accordance with standard SIP usage, the ITF 106 acknowledges the NOTIFY message with a SIP 200 OK message (step 190). It will be appreciated that for steps 188 and 190, the user's ITF will have previously requested to receive notifications of changes to the profile using a SIP SUBSCRIBE message containing an xcap-diff event package or the like for the bookmark application. In response to such request, the SIP NOTIFY message is sent in step 188 to the ITF used to generate the bookmark request.

A NOTIFY message is also sent to other ITFs associated with the user that have subscribed to receive such notifications by sending a SUBSCRIBE message from that ITF asking to receive changes to the profile using an xcap-diff event package. For a new ITF, i.e., an ITF that does not have a copy of the user's profile, such a subscription request can result in the user's entire profile being downloaded. Subsequent notifications from the network to that ITF then result in sending only changes to the profile. A NOTIFY message can also be used to notify an ITF that a bookmark has expired, so that the ITF can either delete the bookmark, disable it, or otherwise indicate to the user visually that the bookmark is no longer effective.

The XCAP allows a client to read, write, and modify application configuration data that is stored in XML format on a server. Each such application configuration data can be called an “application usage” and is associated with a unique name called an Application Unique Identifier (AUID). IPTV bookmarks for a user is a specific case of such an application usage and the AUID for such bookmarks is used in an XCAP request together with the user's name to access the logical data store where that user's bookmark information is stored.

The artisan will understand that xcap-diff relates to an IETF draft that defines a document format that can be used to indicate that a change has occurred in a document managed by the XCAP. This is useful when several clients share the same XML document stored on a server and use XCAP to change the shared document. Since clients can change the document simultaneously, there is no simple way to ascertain that the document a client has cached in its memory is the most recent version. To deal with this problem, clients can use an event package, such as defined in IETF RFC 3265, to subscribe to change events in XCAP documents. xcap-diff-event is such an event package, and clients subscribing to that event package will be notified of any changes to the XML document of interest. The data format used is an XML document format, called an XCAP diff document, that can indicate that a document has changed, and provide its previous and new entity tags. It can also optionally include a set of patch operations, e.g., I-D.ietf-simple-xml-patch-ops, which indicate how to transform the document from the version prior to the change to the version after it. XML element and attribute content of XCAP documents can also be delivered with this format.

FIG. 3 depicts an example of an XCAP PUT message that can be sent from the IPTV control server to the IPTV user profile server. As noted above, XCAP is a protocol that allows fragments of XML information to be easily recognized and exchanged between functions that form a complete system. With XCAP, it is not necessary to send an entire user profile in order to update it with a bookmark. As can be seen in FIG. 3, the XCAP message includes the bookmark address (“http://userprofileserver.iptvprovider.com . . . ”), the URI of the media information (“<entry uri= . . . ”), a time displacement from the start of the media information (“<time-offset> . . . ”), the time at which the bookmark ceases to be available (“<expiration> . . . ”), and the bookmark display name (“<display-name> . . . ”). It will be noted that the user, who in FIG. 3 is identified by the information element sip:username@iptvprovider.com, is known to the IPTV control server 108 and IPTV user profile server 112 from a previous identification and authentication procedure, during which the user registered with the IPTV control server 108 from that ITF 106.

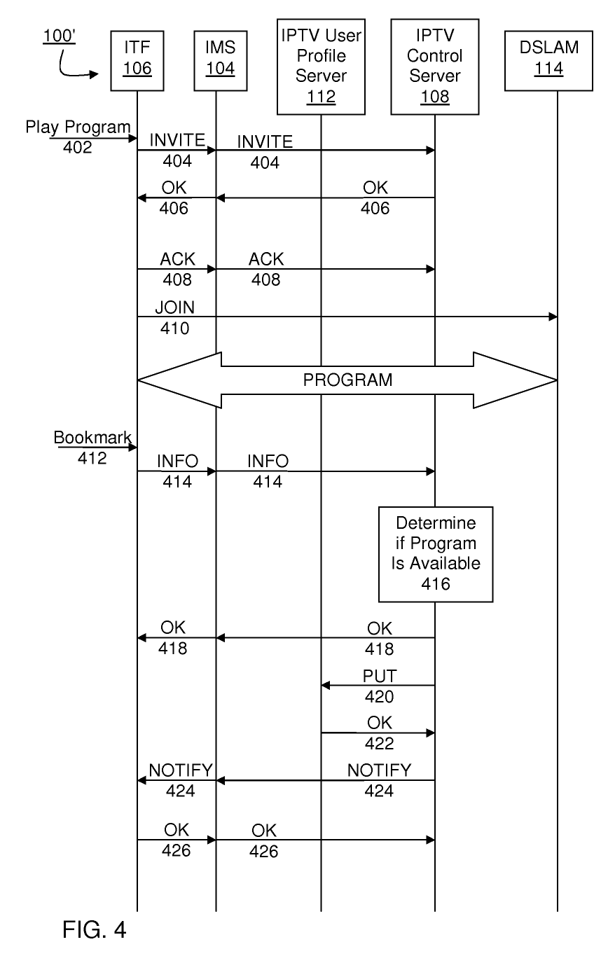

FIG. 4 depicts a typical signal flow among entities in another communication network 100′ in a method of media bookmarking for linear TV in accordance with this invention. Linear TV is generally a program of media information presented according to a predefined schedule.

In step 402, a user indicates a request to view a linear TV program that the user can access with an ITF 106 implemented by an access device such as a STB. The user may indicate the request in many ways, for example by clicking on a link or URI in a browser application running on the UE.

Steps 404-408 relate to the process of establishing an IMS control session for linear TV. In step 404, the user's ITF 106 arranges for a SIP INVITE message to be sent to the IMS 104, which forwards the user's request to the IPTV control server 108 associated with the IMS 104. The IPTV control server 108 in step 406 replies with a SIP 200 OK message that is forwarded to the ITF 106 through the IMS 104. In step 408, the ITF 106 responds with the appropriate acknowledgement message that passes from the IMS to the IPTV control server and indicates that the IMS session is established.

In step 410, the ITF 106 issues an Internet Group Management Protocol (IGMP) JOIN message to join the multicast address for the linear TV channel requested by the user. The JOIN message is sent to a digital subscriber line access multiplexer (DSLAM) 114 or other suitable network device, with the result that content in the linear TV channel is delivered to the user's ITF 106. A DSLAM is generally a multiplexer that can connect several users to the network, and multicast groups are an efficient and currently prevalent mechanism for delivering linear TV channels across communication networks. IGMP is used by IP hosts to manage IP multicast groups and by connected routers to discover group members for streaming video and other content. IGMP version 1 is defined by RFC 1112, IGMP version 2 is defined by RFC 2236, and IGMP version 3 is defined by RFC 3376.

In step 412, the user indicates to the ITF 106 a request to bookmark a point or scene in the program, for example by clicking on the UE's display or a particular button or other control device associated with bookmarking on the UE, remote control, etc. In response to the user's request, bookmark functionality in the ITF 106 can suggest a display name for the bookmark, which may be based on the title of the program and/or other characteristics, and can enable the user to modify the suggested display name of the bookmark at the time of the request, or if done later, through a procedure for modifying stored bookmarks.

In step 414, the ITF 106 sends a SIP INFO message to the IMS 104, which forwards the message to the IPTV control server 108. If the ITF 106 has information that the linear TV program is not being recorded, then the ITF 106 would typically not create and send the SIP INFO message and would suitably advise the user. The ITF 106 can obtain such information from the program schedule, which may include an icon or other indication to show whether a program can be bookmarked. The INFO or other suitable message preferably includes at least the following information elements: the program multicast address, a content identifier for the requested program, and the bookmark display name chosen by the user. In step 416, the IPTV control server 108 ascertains whether the program is available; for example, the server determines whether the program is being recorded in the network 100′.

If the program is not being recorded, it is not possible to create a bookmark as the program will not be accessible at a later time, and a suitable message can be provided to the user. The ITF 106 includes the time offset in its bookmark message based on its own timer and copy of the program schedule. The IPTV control server 108 then determines the URI for the descriptor of the program being recorded. If step 416 is completed successfully, the IPTV control server 108 returns (step 418) a SIP 200 OK message to the ITF 106 through the IMS 104 to indicate the success of the operation.

It will be noted that even if a program is being recorded, the IPTV control server typically does not know when the program started playing, i.e., when the JOIN message was sent from the ITF 106 to the DSLAM 114 (step 410). The IPTV control server is unable to calculate the bookmark time, and so the time-offset is determined by the ITF 106.

In steps 420 and 422, the IPTV control server 108 updates the list of bookmarks that are preferably part of a respective user profile stored by the IPTV control server 108 or by an associated IPTV user profile server 112. As described above in connection with FIGS. 1 and 3, the updating advantageously uses the XCAP as an efficient mechanism for updating the user profile with the new bookmark. In step 420, the IPTV control server 108 sends the IPTV user profile server 112 an XCAP PUT message that includes pertinent bookmark information for later program retrieval, such as the bookmark address, the URI for the network-recorded content, the time displacement, and the bookmark display name. The XCAP PUT message may also include an expiration element indicating the validity period of the bookmark. In step 422, the IPTV user profile server 112 responds with a HTTP 200 OK message to indicate successful creation of the bookmark.

In step 424, the user's local bookmark application on the ITF 106 is notified of the added bookmark by a SIP NOTIFY message sent from the I PTV control server 108 to the ITF 106 via the IMS 104. In accordance with standard SIP usage, the ITF 106 acknowledges the NOTIFY message with a SIP 200 OK message (step 426). It will be appreciated that for steps 424 and 426 to occur, the user will have previously subscribed to an xcap-diff event package for the bookmark application as described above.

After a bookmark is created, a user can retrieve his or her list of bookmarks simply by accessing his or her IPTV user profile from a suitable access device, such as a STB or other UE, and such access can be performed from a device other than that on which the bookmark was created. When logging in or otherwise signing onto the IPTV system through a browser, the user is typically presented with a menu of selectable links, one of which can be a link to “IPTV bookmarks”. By selecting that link, the user's ITF sends a request to the IPTV user profile server, which has stored the IPTV bookmarks as described above, to retrieve the stored bookmarks.

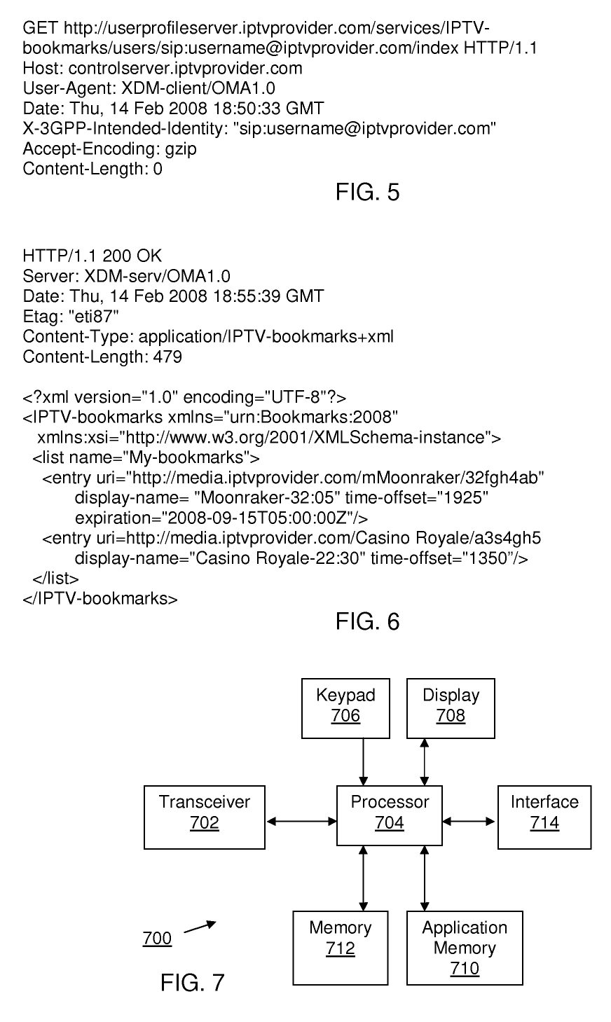

FIG. 5 depicts an XCAP GET message, which is a suitable request message, to fetch a specific user's bookmarks from the bookmarks portion of a user's profile. The bookmarks AUID is called “IPTV-Bookmark” in FIG. 5. The request message includes information elements that identify the user (e.g., “sip:username@iptvprovider.com”) and the service provider (e.g., “iptvprovider.com”).

It will be appreciated that before acting on a request message, the IPTV user profile server 112 or another network entity would typically invoke suitable user authentication and access control procedures, e.g., requiring the user to enter a username and password. If those procedures are completed successfully and access is granted, the list of bookmarks is returned in a suitable message.

FIG. 6 depicts a HTTP 200 OK message that is suitable for returning retrieved bookmarks from the IPTV user profile server 112 to an ITF 106. It can be seen in FIG. 6 that the message includes the URI of each bookmark (“<entry uri= . . . ”), a time displacement from the start of the program (“time-offset= . . . ”), and a bookmark list name (“<list name= . . . ”), with items of the bookmark returned as attributes of the bookmark entry. Each bookmark entry can include expiration information (“expiration= . . . ”), such as a date and time, if such information was set when the bookmark was created. These results are displayed to the user, who can select from the displayed results. The web browser included in the ITF 106 in the user's access device parses the message. The artisan will understand that the user can use the web browser in the ITF 106 to modify or edit one or more bookmarks selected from a list of bookmarks and send the changes to the network using suitable XCAP messages to modify the XML document representing the listed bookmarks.

It will be understood that a list of bookmarks can be retrieved in many ways that begin in substantially the same way. After the IPTV user profile server 112 saves the information pertaining to a bookmark in the user's profile, the IPTV user profile server 112 sends an OK message (steps 186 and 422) to the IPTV control server 108. The IPTV control server 108 sees the OK message as a successful save and generates a SIP NOTIFY message (steps 188 and 424). The SIP NOTIFY message contains an XML body that describes the bookmark information. Such an XML body can basically be the same as that in the PUT message sent by the IPTV control server 108 to the IPTV user profile server 112 requesting the bookmark to be saved, but can include network-added elements, such as the time-offset). The ITF 106 can use the information in such a SIP NOTIFY message to update its local bookmarks list.

A bookmark that is related to a media content as described in this application and not to a device used for displaying the media content and for creating the bookmark provides a user with many more capabilities for program playback as the bookmark can be accessed and used from any suitable device available to the user. Such capabilities are particularly useful, for example, with interactive TV, enabling the state of a game or other interactive content to be captured and subsequently restored. Moreover, with an IPTV-Bookmarks XCAP Application Usage, bookmark requests can be translated into XCAP requests that easily add entries to user profiles in a suitable directory. Users can access the directory from any device, after appropriate authentication, and retrieve stored bookmarks.

The artisan will understand that the methods and apparatus described in this application can be implemented in many types of electronic communication networks, such as mobile radio networks.

FIG. 7 is a block diagram of a typical UE 700, such as a mobile phone, STB, computer, etc., for accessing and rendering media program content as described in this application. The UE 700 includes a transceiver 702 that is suitable for exchanging electronic signals with one or more of the network entities depicted in FIGS. 1 and 4. Information carried by those signals is handled by a processor 704, which may include one or more sub-processors, and which executes one or more software modules and applications, including for example the ITF 106, to carry out the operations of the UE 700 described above. User input to the UE 700 is provided through a keypad, remote control, or other device 706, and information presented to the user is provided to a display 708. If the display has touch-screen capabilities, user input can be provided through the display. Software applications may be stored in a suitable application memory 710, and the UE may also download and/or cache desired information in a suitable memory 712. The UE 700 may also include an interface 714 that can be used to connect other components, such as a computer, microphone, etc., to the UE 700.

In creating a bookmark, the ITF 106 receives a bookmark request via the keypad 706 or the interface 714 that is passed to the processor 704, which through the previous session establishment, has information in the memory 712 of the content or program being presented to the user. The processor 704 also knows the time offset into the program based on its own copy of the program schedule in the memory 712, and with that information, the processor 704 forms the appropriate SIP INFO message (step 176 or 414) and sends it to the IMS 104 via transceiver 702. The transceiver 702 receives the SIP NOTIFY message (step 188 or 424) indicating an update to the user's bookmarks, and the processor 704 records the update in its local copy of the bookmarks in the memory 712. The ITF 106 acknowledges receipt of the SIP NOTIFY message by having the processor 704 form a SIP 200 OK message that is sent by the transceiver 702 to the network (step 190 or 426), and the processor 704 may then present an indication of the bookmark or the actual bookmark itself to the user via the display 708.

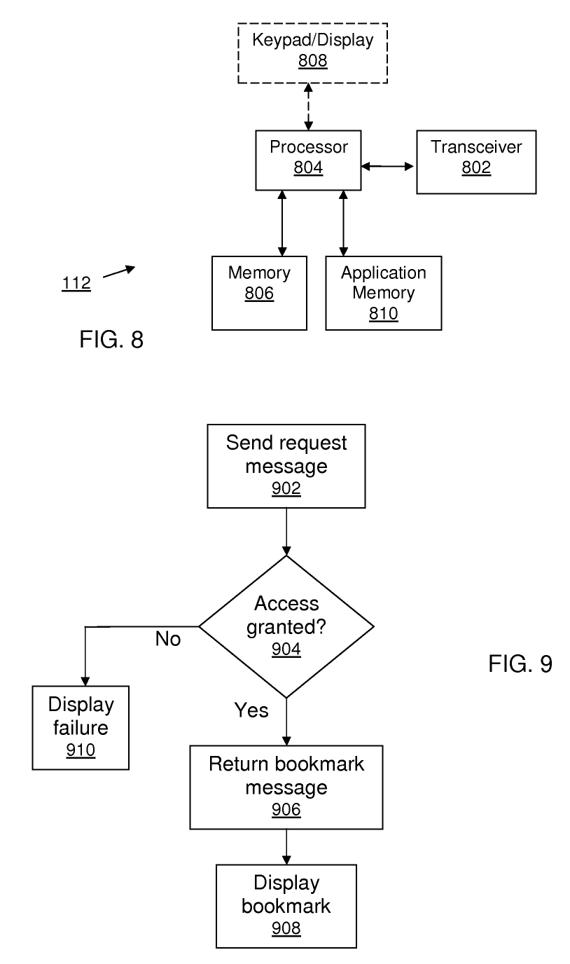

FIG. 8 is a block diagram of a typical IPTV user profile server 112 for storing and retrieving bookmarks on request as described in this application. The IPTV user profile server 112 includes a transceiver 802 that is suitable for exchanging electronic signals with one or more of the network entities depicted in FIGS. 1 and 4. Information carried by those signals is handled by a processor 804, which may include one or more sub-processors, and which executes one or more software modules and applications to carry out the operations of the IPTV user profile server 112 described above. In particular, the processor 804 stores user bookmarks in a suitable memory 806 and in response to received requests retrieves selected bookmarks from the memory 806. It will be understood that a typical IPTV user profile server 112 is a database server in the network and so a keypad/display 808 is usually not needed for user input/output, although such interfaces may be provided for administrative functions. Software applications executed by the processor 804 may be stored in a suitable application memory 810.

FIG. 9 is a flowchart that depicts a method of retrieving a bookmark from the IPTV user profile server 112. As described above, a user retrieves his or her list of bookmarks by sending (step 902) a request, preferably an XCAP GET message such as that depicted in FIG. 5, from the user's UE to the IPTV user profile server 112. Sending such a request may include logging in or otherwise signing onto the IPTV system and possibly providing a username and password to the IPTV user profile server 112. If access is granted (Yes in step 904), the list of bookmarks is returned (step 906) to the user's UE by the IPTV user profile server 112 in a suitable message, such as an HTTP 200 OK message like that depicted in FIG. 6. The returned bookmark or list of bookmarks can be returned to various UEs as described above. At the user's UE, the returned message is advantageously parsed by a browser or other suitable application implemented by user's UE, and the retrieved bookmark or bookmark list is presented on the UE's display (step 908). If access is not granted (No in step 904), a failure or similar error message is presented on the UE's display.

The invention described here can be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or medium. More specific examples (a non-exhaustive list) of the computer-readable medium include an electrical connection having one or more wires, a portable computer diskette, a RAM, a ROM, and an erasable programmable read-only memory (EPROM or Flash memory).

It is expected that this invention can be implemented in a wide variety of environments, including for example mobile communication devices. It will also be appreciated that procedures described above are carried out repetitively as necessary. To facilitate understanding, aspects of the invention are described in terms of sequences of actions that can be performed by, for example, elements of a programmable computer system. It will be recognized that various actions can be performed by specialized circuits (e.g., discrete logic gates interconnected to perform a specialized function or application-specific integrated circuits), by program instructions executed by one or more processors, or by a combination of both. Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action. It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

1. A method of bookmarking media information displayed to a user of an electronic communication network (100; 100′), comprising:
(a) generating a bookmark request message, wherein the bookmark request message includes at least an identifier of the user, an identifier of the media information, a time indicator, and a bookmark display name;
(b) sending the bookmark request message to a control server (108; 112) in the communication network; and
(c) updating a list of bookmarks based on the bookmark request message.

2. The method of claim 1, wherein the media information is either media content or a media program.

3. The method of claim 2, further comprising determining whether the media program is being recorded in the network, and if the media program is not being recorded, sending a not-available message in response to the bookmark request message.

4. The method of claim 1, further comprising retrieving a bookmark and sending the retrieved bookmark to at least one user equipment.

5. The method of claim 1, further comprising subscribing to receive notification of changes to the list of bookmarks, and sending at least one notification message that indicates a change in the list of bookmarks.

6. The method of claim 1, wherein generating the bookmark request message includes suggesting a display name based on at least one characteristic of the media information.

7. The method of claim 1, wherein the bookmark request message is a SIP INFO message.

8. The method of claim 1, wherein the time indicator is a time displacement from a start of the media information to a time of generating the bookmark request message.

9. The method of claim 1, wherein updating the list of bookmarks comprises including an expiration indication in a bookmark.

10. The method of claim 1, wherein the bookmark request message includes metadata of the media information.

11. The method of claim 10, wherein the media information is interactive media content, and the metadata is such that a state of the interactive media content can be restored.

12. The method of claim 1, wherein the list of bookmarks is associated with a stored profile of the user.

13. The method of claim 12, wherein the profile is stored by the control server.

14. The method of claim 1, wherein updating the list comprises sending an update message from the control server to a user profile server configured to store a profile of the user, and the update message is in accordance with an eXtensible Mark-up Language Configuration Access protocol (XCAP).

15. The method of claim 14, wherein the update message is an XCAP PUT message that indicates the identifier of the media information, the time displacement, and the bookmark display name.

16. A user equipment (700) for an electronic communication network (100; 100′) for accessing and rendering media information, comprising:
a transceiver (702) configured to exchange electronic signals with one or more entities (104; 110; 114) in the network;
an electronic processor (704) programmably configured to handle information carried by the electronic signals according to instructions in a memory (710, 712); and
a device (706; 708) configured to provide user input to the electronic processor;
wherein the processor is configured for an Internet Protocol Television (IPTV) function able to bookmark media information displayed to a user at least by:
(a) generating a bookmark request message, wherein the bookmark request message includes at least an identifier of the user, an identifier of the media information, a time indicator, and a bookmark display name; and
(b) sending the bookmark request message to a control server (108; 112) in the communication network.

17. The user equipment of claim 16, wherein the bookmark request message is a SIP INFO message.

18. The user equipment of claim 16, wherein the time indicator is a time displacement from a start of the media information to a time of generating the bookmark request.

19. The user equipment of claim 16, wherein the bookmark request message includes metadata of the media information, and if the media information is interactive media content, and the metadata is such that a state of the interactive media content can be restored.

20. An Internet Protocol television user profile server (112) for storing and retrieving bookmarks on request, comprising: a transceiver (802) configured for exchanging electronic signals with one or more entities (104; 108) of an electronic communication network (100; 100′);
an electronic processor (804) programmably configured to handle information carried by the electronic signals; and
a memory (806; 810) configured to store retrievable bookmarks;
wherein the processor is configured to store a list of media information bookmarks in association with a profile of a user, the list including at least an identifier of the media information, a time indicator, and a bookmark display name.

21. The server of claim 20, wherein the list is updated based on an update message received from a control server, and the update message is in accordance with an eXtensible Mark-up Language Configuration Access protocol (XCAP).

22. The server of claim 21, wherein the update message is an XCAP PUT message that indicates the identifier of the media information, the time displacement, and the bookmark display name.
